(19) United States
(12) Patent Application Publication
(10) Pub. No.: US 2011/0076043 A1
(43) Pub. Date: Mar. 31, 2011

(54) FIXING DEVICE

(75) Inventors: Kazuhiko KIKUCHI, Kanagawa-ken (JP); Satoshi Kinouchi, Tokyo (JP); Shuji Yokoyama, Shizuoka-ken (JP); Hiroyuki Kunugi, Shizuoka-ken (JP); Hiroshi Nakayama, Shizuoka-ken (JP); Yoshiaki Okano, Shizuoka-ken (JP); Setsuo Takada, Shizuoka-ken (JP); Toshihiro Sone, Kanagawa-ken (JP)

(73) Assignees: Kabushiki Kaisha Toshiba, Tokyo (JP); Toshiba Tec Kabushiki Kaisha, Tokyo (JP)

(21) Appl. No.: 12/890,570

(22) Filed: Sep. 24, 2010

Related U.S. Application Data
(60) Provisional application No. 61/246,491, filed on Sep. 28, 2009.
(60) Provisional application No. 61/246,485, filed on Sep. 28, 2009.
(60) Provisional application No. 61/246,495, filed on Sep. 28, 2009.

(51) Int. Cl. G03G 15/20

(52) U.S. Cl. 399/69

(57) ABSTRACT

A fixing device includes a belt that has an endless shape, a roller that forms a nip with the belt, a support member that supports the belt interposed between the support member and the roller, a coil that generates a magnetic field for inducing current in the belt, an auxiliary heat generation member that generates heat with the current induced by the magnetic field in the loop of the belt, and a temperature sensor that is opposed to the auxiliary heat generation member with the belt interposed between the element and the auxiliary heat generation member and detects the temperature of an outer peripheral surface of the belt.

### CROSS-REFERENCE TO RELATED APPLICATION(S)

This application is based upon and claims the benefit of priority from: U.S. provisional application 61/246,491, filed on Sep. 28, 2009; U.S. provisional application 61/246,485, filed on Sep. 28, 2009; and U.S. provisional application 61/246,495, filed on Sep. 28, 2009; the entire contents all of which are incorporated herein by reference.

### FIELD

Embodiments described herein relate generally to a technique to detect the temperature of an induction heated belt surface in a non-contact manner.

### BACKGROUND

Hitherto, with an energy-saving technique, reduction in heat capacity of a heating target member and quick temperature rising by induction heating or the like are possible.

In a fixing device of a system in which a belt is heated by induction heating, a structure is known in which a non-contact type thermostat detects the temperature of a surface of the belt on the side of contact with a sheet.

In the structure using the non-contact type thermostat, there is a case where a gap between the thermostat and the belt is not stably maintained, and this is a problem in stabilizing the performance of the thermostat.

### DESCRIPTION OF THE DRAWINGS

FIG. 1 is a perspective view of an image forming apparatus.

FIG. 2 is a view showing an example of an auxiliary heat generating member.

FIG. 3 is a sectional view showing a structure of an auxiliary heat generating member 6′ in a second embodiment.

FIG. 4 is a sectional view showing a schematic structure of an auxiliary heat generating member 6″ in a third embodiment.

### DETAILED DESCRIPTION

In general, according to embodiments, a fixing device includes a belt, a roller, a support member, a coil, an auxiliary heat generation member, and a temperature sensor.

The belt is a belt having an endless shape.

The nip forming member is arranged inside the belt.

The roller forms a nip with the belt.

The support member supports the belt interposed between the member and the roller.

The coil generates a magnetic field for inducing current in the belt.

The auxiliary heat generation member generates heat with the current induced by the magnetic field in the loop of the belt.

The temperature sensor is opposed to the auxiliary heat generation member with the belt interposed between the element and the auxiliary heat generation member and detects the temperature of an outer peripheral surface of the belt.

Hereinafter, embodiments will be described with reference to the drawings.

### First Embodiment

First, a first embodiment will be described.

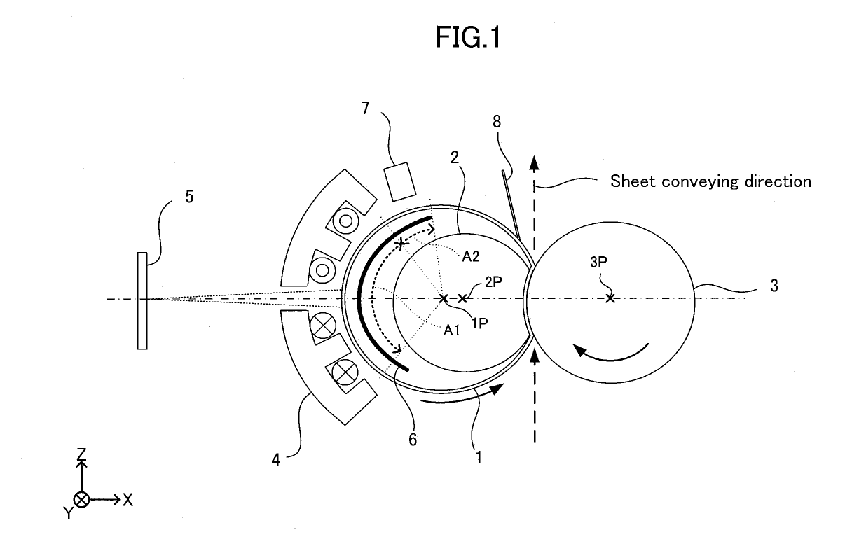

FIG. 1 is a view showing a schematic structure of a fixing device of a first embodiment.

As shown in FIG. 1, a fixing device according to First Embodiment includes a belt 1, a nip forming member (support member) 2, a roller 3, a coil 4, a temperature sensor 5, a thermostat 7, an auxiliary heat generation member 6 and a thermostat 7.

The belt 1 is an endless belt.

The belt 1 has a multi-layer structure in which at least a release layer and a heat generating layer are laminated from the side of contact with a sheet which is an object of a fixing process. It is needless to say that an elastic layer can be provided between the release layer and the heat generating layer.

Here, for example, PFA (polytetrafluoroethylene) is adopted as the release layer, and for example, Ni is used as the heat generating layer. Of course, nonmagnetic metal (stainless, silver, copper, aluminum, etc.) can also be used as the heat generating layer.

The nip forming member 2 is arranged inside the belt 1.

The nip forming member 2 is made of, for example, a heat-resistant silicone sponge or silicone rubber. In the first embodiment, although a roller shape rotating around a rotation center axis 2p is adopted as the nip forming member 2, a non-rotating fixed member can also be adopted.

The roller 3 nips the belt 1 in cooperation with the nip forming member 2 and forms a nip.

The coil 4 heats the belt 1 by induction heating.

The thermostat 7 is arranged to be opposite to apart of the auxiliary heat generating member through the belt 1, and detects the temperature of the outer peripheral surface of the belt 1 in a non-contact manner.

As the thermostat 7, for example, a thermopile type non-contact temperature detection element or a non-contact thermistor can be adopted so that a friction load is not applied to the surface of the belt 1. The thermostat 7 is arranged so that at least a part thereof is positioned above the belt 1.

The temperature detection element 5 is arranged at a side of the belt 1. In the first embodiment, the nip forming member 2 and the roller 3 are arranged horizontally. By this, while the size of the fixing device in height direction is not enlarged, and it is avoided that heat is excessively applied to the temperature detection element 5, the temperature detection element 5 can detect the temperature of the surface of the belt 1.

The auxiliary heat generating member 6 is arranged inside the belt 1. The auxiliary heat generating member 6 includes a conductive material, and generates Joule heat by induction heating of the coil 4.

Besides, the auxiliary heat generating member 6 is formed to have an arc shape along the inner peripheral surface of the belt 1, and at lease one end (here, an upper end) in the peripheral direction of the belt 1 extends to a non-opposite area A2 which is not opposite to the coil 4.

The thermostat 7 is arranged to be opposite to the auxiliary heat generating member 6 in the non-opposite area A2 through the belt 1. As stated above, also when the non-contact thermostat 7 is adopted which is required to accurately maintain the distance to an object as a temperature detection object, the back side in an area where the temperature is detected by the thermostat 7 is guided by the auxiliary heat generating member 6, so that fluttering or undulating in the portion of the belt 1 facing the thermostat 7 can be suppressed. As a result, the performance of the thermostat 7 can be stably exhibited.

Besides, the thermostat 7 is made opposite to the non-opposite area A2 (area outside a heating target area A1 of the coil 4) where the auxiliary heat generating member 6 is not opposite to the coil 4. Thus, it is possible to reduce a possibility that the thermostat 7 receives the influence of a magnetic flux from the coil 4. Besides, since the non-opposite area A2 is continuous with the heating target area A1, when a phenomenon such as abnormal overheat occurs in the heating target area A1, the thermostat 7 can detect the abnormal overheat in the heating target area A1 by the heat transmitted from the heating target area A1 to the non-opposite area A2.

Besides, the non-opposite area A2 of the auxiliary heat generating member 6 is provided on the upper end side of the auxiliary heat generating member 6.

When consideration is given to the characteristic that heat transfers upward, in order to realize more accurate temperature detection, it is preferable to arrange the thermostat upward with respect to the belt to the extent possible. Accordingly, in the peripheral direction, “a direction in which the auxiliary heat generating member 6 is projected to a position not opposite to the coil 4” is upward.

Further, in the first embodiment, the auxiliary heat generating member 6 is projected from the coil 4 in at least one direction of directions parallel to a rotation axis 3p. The thermostat 7 is arranged to be opposite to the portion of the non-opposite area A2 projecting from the coil 4 in the direction parallel to the rotation axis 3p.

In the heat generating layer (conductive layer) of the belt 1, reduction in heat capacity (reduction in thickness) is performed in order to enable quick temperature rising by induction heating.

Accordingly, the magnetic field generated by the coil 4 passes through the heat generating layer of the belt 1, and reaches a heat generating layer 6b (the details will be described later) of the auxiliary heat generating member 6. By this, Joule heat is generated in the belt 1 and the auxiliary heat generating member 6, and the belt 1 is heated.

Besides, when the thermostat 7 is arranged as shown in the first embodiment, as compared with a structure in which a contact-type thermostat is arranged inside the belt, the size of the device can be greatly reduced. Besides, since the temperature of the surface of the belt 1 is measured in a non-contact manner, the outer peripheral surface of the belt 1 is not damaged.

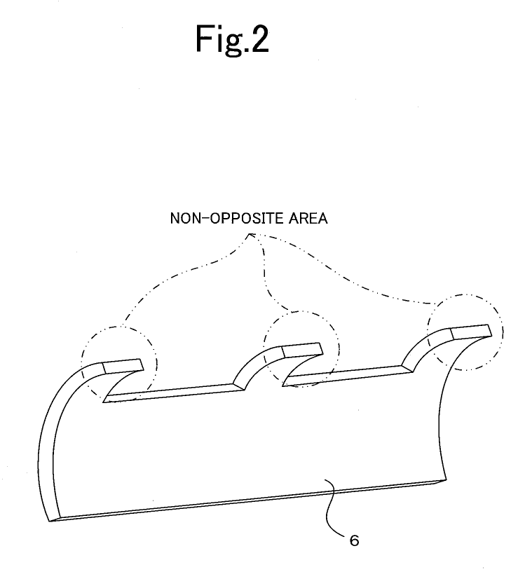

Incidentally, it is not necessary that the non-opposite area A2 is provided in the same range as the width of the auxiliary heat generating member 6 in the direction parallel to the rotation axis 3p, and the non-opposite area has only to be provided at least at a position opposite to the thermostat 7 (see FIG. 2).

By this, the yield of material when the auxiliary heat generating member is formed can be improved, and this can contribute to reduction in cost.

As described above, according to the first embodiment, it becomes easy to stably maintain the gap between the outer peripheral surface of the belt 1 and the thermostat 7. Besides, it becomes possible to detect abnormal heat generation of the auxiliary heat generating member 6.

### Second Embodiment

Next, a second embodiment will be described.

The second embodiment is a modified example of the first embodiment. Accordingly, a portion having the same function as a portion described in the first embodiment is denoted by the same reference numeral and its description will be omitted.

In the second embodiment, in order to enable quick temperature rising, a structure for reducing influence of temperature unevenness (gloss unevenness) in a thin belt is added.

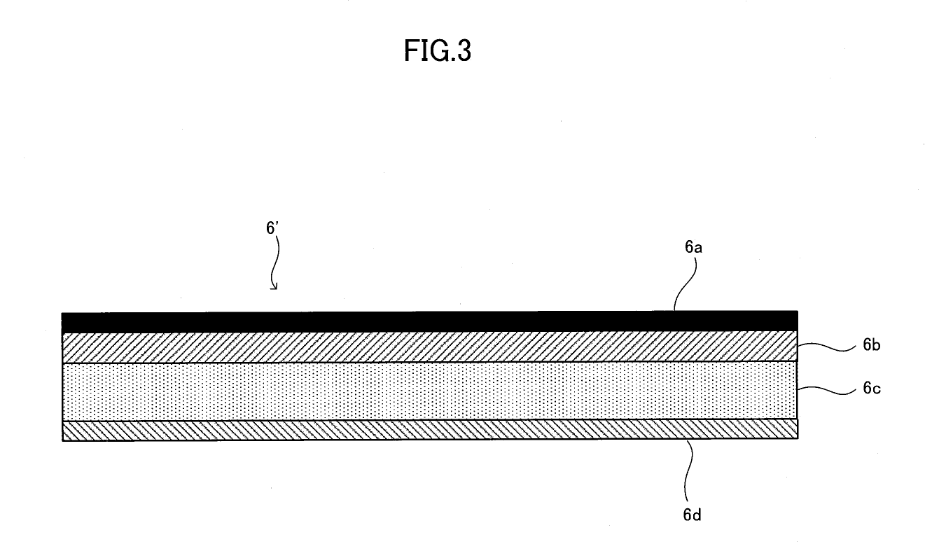

The auxiliary heat generating member 6′ in the second embodiment has a structure as shown in FIG. 3.

The auxiliary heat generating member 6′ has a multi-layer structure in which a release layer 6a, a heat generating layer 6b, a soaking layer 6c, and a radiation prevention layer 6d are laminated from the inner surface side of the belt 1 toward the nip forming member 2.

The release layer 6a is made of a material having a low friction coefficient and high heat resistance in order to maintain a gap with respect to the coil 4 and a gap with respect to the thermostat 7 when the belt 1 contacts with the auxiliary heat generating member 6′.

The heat generating layer 6b is formed of a metal layer which can be induction heated. Incidentally, a magnetic shunt metal having a Curie point of about 230° C. may be adopted as the heat generating layer 6b so that the heat generating layer 6b does not abnormally generate heat.

The soaking layer 6c is arranged in order to prevent temperature fluctuation in the direction of the rotation axis 3p of the belt from occurring by passing of a sheet (small size sheet such as a B5 sheet) having a small size in the direction parallel to the rotation axis 3p. A material having high heat conductivity such as, for example, copper or aluminum can be adopted as the soaking layer 6c. Besides, a functional material such as a heat pipe can be adopted as the soaking layer 6c.

The width of the soaking layer 6c in the direction of the rotation axis 3p of the roller 3 is narrower than the width of the coil 4 in the direction of the rotation axis 3p of the roller 3, and is wider than the width of a maximum size sheet conveyed by the roller 3 in the direction of the rotation axis 3p of the roller 3.

When the width of the soaking layer 6c is excessively wide, since heat generated in the heat generating layer 6b is significantly absorbed by the soaking layer 6c, the width is set to become necessary and sufficient for a fixing process of a sheet as a fixing object.

Besides, the width of the heat generating layer 6b in the direction of the rotation axis 3p of the roller 3 is wider than the width of the coil 4 in the direction of the rotation axis 3p of the roller 3. Besides, the width of the heat generating layer 6b in the direction of the rotation axis 3p of the roller 3 can be made wider than the width, in the direction of the rotation axis 3p, of an area of the belt 1 where the temperature reaches a specified fixing temperature at the time of a fixing process.

Incidentally, here, although the description is made on the example of the multi-layer structure in which the release layer 6a, the heat generating layer 6b, the soaking layer 6c and the radiation prevention layer 6d are laminated in this order, it is needless to say that the multi-layer structure may be such that the release layer 6a, the soaking layer 6c, the heat generating layer 6b and the radiation prevention layer 6d are laminated in this order.

As described above, according to the second embodiment, the occurrence of temperature unevenness in the auxiliary heat generating member 6′ can be suppressed, and reduction in picture quality (gloss unevenness) due to the temperature unevenness of a belt period can be prevented.

### Third Embodiment

Next, a third embodiment will be described.

The third embodiment is a modified example of the first and the second embodiments. Accordingly, a portion having the same function as a portion described in the first and the embodiments is denoted by the same reference numeral and its description will be omitted.

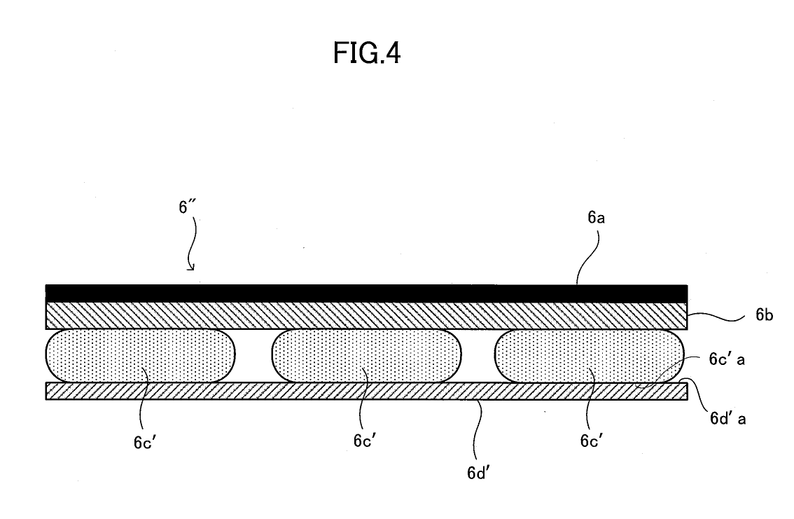

FIG. 4 is a sectional view showing a schematic structural view of an auxiliary heat generating member 6″ in the third embodiment.

As shown in FIG. 4, in the auxiliary heat generating member 6″ in the third embodiment, in addition to the object of protecting a soaking layer 6c′, a radiation prevention layer 6d′ prevents heat from being radiated to a nip forming member 2 from the auxiliary heat generating member 6″.

The radiation prevention layer 6d′ has a heat conductivity lower than that of either one (here, the soaking layer 6c′) of the heat generating layer 6b and the soaking layer 6c′, which is closer to the nip forming member 2.

By this, it is possible to prevent that heat generated in the heat generating layer 6b escapes to the nip forming member 2. As a result, the heat generated in the heat generating layer 6b can be efficiently transmitted to the belt 1.

Besides, a surface 6d′a of the radiation prevention layer 6d′ on the belt side has a color having higher lightness than that of a surface 6c′a, on the nip forming member 2 side, of either one (here, the soaking layer 6c′) of the heat generating layer 6b and the soaking layer 6c′, which is closer to the nip forming member 2. For example, the surface 6d′a can be made white, and the surface 6c′a can be made black.

By this, it is possible to suppress that heat generated in the heat generating layer 6b of the auxiliary heat generating member 6″ is transferred to the nip forming member 2 side, and the belt 1 can be efficiently heated.

Incidentally, it is needless to say that not only the techniques described in the first to the third embodiments are individually adopted, but also they can be arbitrarily combined with each other and can be adopted.

As described above in detail, according to the technique disclosed in the specification, it is possible to provide the technique to stably maintain the gap between the induction heated belt and the non-contact thermostat to detect the temperature of the belt surface.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A fixing device comprising:
a belt that is conductive;
a roller that forms a nip with the belt;
a support member that supports the belt interposed between the support member and the roller;
a coil that generates a magnetic field to induce current in the belt;
an auxiliary heat generation member that generates heat with the current induced by the magnetic field in a loop of the belt; and
a temperature sensor that is opposed to the auxiliary heat generation member with the belt interposed between the element and the auxiliary heat generation member and detects a temperature of an outer peripheral surface of the belt.

2. The fixing device of claim 1, wherein the auxiliary heat generation member comprises an arc shape formed along an inner peripheral surface of the belt and at least one end portion of the auxiliary heat generation member in a circumferential direction of the belt extends to a non-opposed region that is not opposed to the coil.

3. The fixing device of claim 2, wherein the temperature sensor is opposed to the auxiliary heat generation member in the non-opposed region with the belt interposed between the element and the auxiliary heat generation member.

4. The fixing device of claim 3, wherein the non-opposed region lies on an upper-end side of the auxiliary heat generation member.

5. The fixing device of claim 3, wherein the non-opposed region lies only in a position of the auxiliary heat generation member that is opposed to the temperature sensor.

6. The fixing device of claim 1, wherein the support member lies on a side of the roller.

7. The device of claim 1, further comprising a thermostat at least a part of which is positioned above the belt.

8. The device of claim 1, wherein the auxiliary heat generating member includes a release layer, a heat generating layer including a conductive material, and a soaking layer.

9. The device of claim 8, wherein a width of the soaking layer in a rotation axis direction of the roller is narrower than a width of the coil in the rotation axis direction of the roller, and is wider than a width, in the rotation axis direction of the roller, of a maximum size sheet conveyed by the roller.

10. The device of claim 8, wherein a width of the heat generating layer in a rotation axis direction of the roller is wider than a width of the coil in the rotation axis direction of the roller.

11. The device of claim 8, wherein the release layer among the release layer, the heat generating layer and the soaking layer is closest to the belt.

12. The fixing device of claim 8, wherein the auxiliary heat generation member further includes a radiation preventing layer that is located closer to the support member than the release layer, the heat generation layer, and the soaking layer.

13. The device of claim 8, wherein the soaking layer includes a heat pipe.

14. The fixing device of claim 8, wherein the radiation preventing layer comprises a lower thermal conductivity than a thermal conductivity of one of the heat generation layer and the soaking layer that is closer to the support member.

15. The fixing device of claim 8, wherein a surface of the radiation preventing layer on the side of the belt comprises a color having a higher lightness than a lightness of a color of a surface of one of the heat generation layer and the soaking layer that is closer to the support member, the latter surface being on the side of the support member.
